(19) United States
(12) Patent Application Publication
(10) Pub. No.: US 2006/0113930 A1
(43) Pub. Date: Jun. 1, 2006

(54) Control device for variable speed electric motors, particularly for power tools

(76) Inventor: Paolo Andriolo, Creazzo (IT)

Correspondence Address: VENABLE LLP, P.O. BOX 34385, WASHINGTON, DC, 20045-9998, US

(21) Appl. No.: 10/541,545

(22) PCT Filed: Jan. 9, 2004
(86) PCT No.: PCT/IB04/00027

§ 371 Date: Jul. 6, 2005

(30) Foreign Application Priority Data
Jan. 9, 2003 (IT) VI2003A000002

(51) Int. Cl. H02P 5/00

(52) U.S. Cl. 318/66

(57) ABSTRACT

A device for controlling variable speed electric motors, particularly for hand held power tools and other miniaturised electrically powered apparatuses, comprises an electronic driver unit (5) connectable to the terminals (2, 3) of an electric power source for supplying electric current to at least one electric motor (M) and an optical switch device (7) for triggering the electronic driver unit (5). The optical switch device (7) comprises light emitting means (8) and light transducer means (9) for detecting and converting light into an electric variable signal. The light transducer means (9) are operatively connected to the electronic driver unit (5) for controlling the electric motor (M). The light emitter means (8) comprise at least one white light, high brightness LED (D1, D2) connected in parallel to the electric power line terminals (2, 3) by means of a miniaturised power circuit. The miniaturised power circuit comprises at least one resistor (R2) when said at least one electric motor (M) is a DC motor, and a capacitive phase displacement power supply (C, R2) when said electric motor is an AC motor. The capacitive phase displacement power supply (C, R2) comprises at least one capacitor (C) and an input resistor (R2) adapted to supply said diodes (D1, D2) with a threshold voltage.

### TECHNICAL FIELD

The present invention relates to a control device for controlling variable speed electric motors. More specifically, the control device of the present invention finds application in the field of the hand held power tools such as e.g. drills, hammer drills, circular, reciprocating and jig saws, routers, planers, sanders, grinders, etc, an other small sized and miniaturised electrically powered apparatuses.

### BACKGROUND ART

Trigger operated control devices are normally housed in the grip handle of power tools in such a manner that they can be operated with the pressure of one or more fingers of the same operator's hand that is holding the tool. Such control devices are used for operating the power tools by means of switching on the motor and adjusting the speed from 0 up to the maximum speed.

The above-mentioned control devices generally comprise each a main mechanical switch to connect the main power to an electronic control circuit, a variable resistor or potentiometer, mechanically connected to the control device, an electronic power circuit triggered by said potentiometer by means of an electric network. Optionally, the control device may further comprise a mechanical switch which is operated at the end of the trigger excursion so as to bypass the electronic circuit and directly connect the main power to the motor in order to get the maximum speed.

In such control devices the potentiometer generally consists of a metal track formed of resistive material on which a movable wiping contact can slide.

By operating the control device the operator varies the pressure on the trigger itself so as to increase or decrease the motor speed related with the excursion of the trigger. By varying said pressure, the wiping contacts are moved along said resistive track so that the value of the resistance changes, to thereby change the speed of the motor.

Though widely emplyed in the industry, such trigger switch devices present several drawbacks. The resistive track is subject to get worn; in order to ensure a good electrical contact between the wiping part and the resistive track, a certain load must be provided between them. Such a load increases the friction between the two parts and therefore make them to get worn with the usage.

Most power tools are used in dusty and wet environments, such as e.g. construction jobsites, yards, workshops etc. Dust and moisture deteriorate the electrical contacts between the wiping parts and the resistive track. Specifically, small particles of dust increase the friction and therefore favour the wear process.

Variations in temperature cause thermal expansion of the metal parts forming the device, thereby modifying the electrical contact.

Vibrations—which are typical of all kinds of power tools and similar apparatuses—can cause micro-gaps of the resistive tracks, therefore affecting the functionality of the device.

Ultimately, the effect of the above-mentioned problems is that of providing a poor interface with the operator, since the speed variation cannot be conveniently controlled by the operator through the time. An initial wearing of the resistive track causes a non-linear variation of the speed (with speed “steps”) with the variation of operator's pressure on the trigger. A further wearing causes gaps so that the motor is not powered in certain positions of the trigger.

As a matter of facts, it is widely statistically proven that the first cause of failure in power tools is due to the trigger switch device. Specifically, according to industry return figures, around 70% of the defect rate of power tools is due to failures of trigger switch devices.

In addition to the above mentioned drawbacks, other important functional implications are related with the overall size of such trigger devices. Specifically, the trigger switch that is housed in the grip handle should be small enough to allow a proper ergonomically convenient size thereof. According to a wide ergonomic literature, the ideal grip member diameter for the average European and North American adult male hand should be between 40 mm and 43 mm. With the existing technology, conventional trigger devices as described above cannot be small enough to allow such an ideal size of the grip. The inconvenient is even worsened by the fact that the number of women using power tools is rapidly increasing. Due to the above mentioned size limitation, a grip handle for matching the substantially smaller female hand size cannot be presently realized.

A variable speed control without any galvanic contact would overcome most of the above-mentioned problems. For this kind of devices the control function can be accomplished in several ways, namely either by means of variation of the magnetic field, by means of variations of the electrical capacity, or by means of variations of electromagnetic waves (light).

Among these possible solutions, the magnetic and capacitive ones are both critical insofar as they are influenced by electromagnetic fields that are normally present in typical working environments—e.g. closeness to metal, electrical appliances and machinery—and even by those electromagnetic fields generated by the electric motor of the power tool itself and by the sparks produced by the brushes.

In view of the above considerations, the most advantageous solution seems to be the “optical” one. An optical system is based on a light emitter, a light transducer and a shield or shutter placed in between and connected to the trigger. In brief, the emitter generates a light beam that is received by the transducer. The transducer converts a certain amount of light into a predetermined electric signal. By varying the amount of light that is received by the transducer by moving the shield, the transducer will generate a correspondingly variable electric signal.

Such known optical control devices provides the advantages of preventing the wear of any wiping part by eliminating wiping contacts, minimizing the influence of dust, reducing the influence of thermal variations.

Optical control devices for driving electric motors are known in the art, see for example U.S. Pat. No. 3,736,479, U.S. Pat. No. 3,582,744, U.S. Pat. No. 3,857,077, EP 381 094, CN 2 069 181.

However, these known optical devices cannot be readily implemented into hand-held power tools insofar as the light emitters used therein make use of bulb lumps and/or neon lamps.

The main limitations associated with bulb lamps are their too large size in comparison with a relatively small grip handle, the excessive heat generation, the high sensitiveness to vibrations, the shorter life than conventional wiping contacts which brings about frequent replacements, which replacements are difficult to perform due to the location of the trigger switch inside the power tool.

The main limitations associated with the use of neon lamps are the too large size, sensitiveness to vibrations, limited light spectrum and consequent limited ability to properly drive the receiver.

As an alternative, LEDs (Light Emitting Diodes) may be used as light emitters. However, up to now the availability of these devices has been limited to single-colour LEDs (e.g. red, green, yellow) whose limited spectrum cannot conveniently drive the receiver unless using several LEDs to increase light concentration. Of course, the use of a plurality of LEDs would have a heavy impact on the size of the trigger switch.

A further disadvantage deriving from this solution is associated with the power supply circuit. In fact, LEDs are operating at low voltage (approx 2V) and therefore require a power transformer to consistently reduce the mains power (110/230V), and such a transformer cannot be easily housed into a hand-held power tool due to its size limitation. A further method for powering LEDs is that of using a resistor voltage divider, but this solution involves a large heat dissipation, thus resulting in excessive waste of energy. Moreover, the adoption of a plurality of LEDs would generate a wide light beam that would require the use of a large shield which cannot be conveniently housed into a limited space.

### SUMMARY OF THE INVENTION

It is a primary object of the present invention to provide a new design of speed control device that is capable of overcoming the afore mentioned drawbacks of the prior art.

A particular object of the present invention is to provide a speed control device, e.g. for power tools, that is considerably efficient and reliable in use and that allows a sound improvement of the life and accuracy relative to the power tools and other apparatuses of the prior art.

Another object of the present invention is to provide a speed control device which is capable to reduce the influence of thermal conditions, dust and mechanical vibrations.

Yet another object of the present invention is that of realising a speed control device, in particular for electric power tools, that makes it possible a substantial reduction of the size of the handle, so that an ergonomic improvement can be achieved.

These and other objects are achieved by means of a speed control device, in particular for electric power tools which, in accordance with claim 1, comprises an electronic driving circuit connectable to an electric power line for supplying at least one electric motor and an optical switch device for triggering said driving circuit, said optical switch device having light emitting means and light transducer means for converting light into an electric variable signal, said light transducer means being operatively connected to said driving circuit for controlling said at least one electric motor, wherein said light emitter means comprise white light, high brightness diodes (LEDs) connected in parallel to the electric power line by means of a miniaturised power circuit.

Thanks to the wide wave spectrum and to the high brightness of the white LEDs, the light transducer means can be conveniently excited in spite of the reduced size of the light emitter means.

Moreover, the light beam generated by the high brightness LEDs is relatively narrow and enables to use a small sized shield that can be conveniently housed into the reduced space of a handle or grip member of a power tool.

Moreover, the reduced size of the miniaturised power circuit for applying an input tension to the LEDs further enables the overall device to be incorporated into a hand-held power tool.

Preferably, when the at least one electric motor is an AC motor the miniaturised power circuit comprises a capacitive phase displacement power supply.

The capacitive phase displacement power supply comprises at least one capacitor and an input resistor adapted to supply said diodes with a threshold voltage.

As an alternative, when the electric motor is a DC motor the miniaturised power circuit comprises one resistor.

Optionally, the light may be generated by a pair of miniaturized LEDs specifically designed and realized for SMD (Surface Mounting Device) purpose. The light is captured by a miniaturized SMD receiver that is centred at the same light spectrum of the emitter, and is adjusted by means of a miniaturized movable shield placed in between said light emitter and light receiver.

The present speed control device provides a very high efficiency, insofar as the LEDs can be powered by means of a very small sized capacitive phase displacement power supply (for AC motor application) or by means of a small resistor (for DC motor application); both these power supplies can be conveniently housed inside a very small available room. Said capacitive phase displacement power supply works as a voltage divider where the values of voltage and current are shifted of 90° each other, so that the power wasted by the capacitor is equal to zero.

The speed control device of the present invention is able to drive control circuits (thyristor) for AC motors and control circuits (MOSFET) for DC motors.

In addition to the main peculiar aspect of avoiding any movable mechanical contact, the control device according to the present invention achieves the following technical advantages: the device is wear-free, has an extremely long life (over 100,000 hours) of the light emitter, which exceeds by far the life of the power tool itself, is insensitive to moisture, vibrations and thermal variations. Moreover the device exhibits very low sensitivity to dust—which in the worst case could only decrease the quantity of the light transmitted, a minor inconvenience that does not prejudice the functionality and is easily compensated by a slight increase of the pressure on the trigger switch

Moreover, the control device according to the present invention achieves the following ergonomic advantages: the interface between the operator and the machine is improved, the shield can be shaped so that it realises a speed variation curve that is convenient to the operator, for a very accurate a precise operation of the speed control, the size of the trigger switch device is substantially reduced, so that is can be housed inside ergonomically convenient grip handles.

The present control device has also a limited cost impact on the finished product, said cost being largely compensated by the advantages in terms of life of the overall apparatus.

### BRIEF DESCRIPTION OF THE DRAWINGS

Further features and advantages of the invention will be more clearly understood from the detailed description of some preferred, but not exclusive embodiments of a speed control device , according to the invention, illustrated by way of a non-limiting example with the aid of the accompanying drawings in which:

FIG. 1 shows a circuit diagrammatic view of a first embodiment of a speed control device according to the present invention;

FIG. 2 shows a circuit diagrammatic view of a second embodiment of a speed control device according to the present invention.

### DETAILED DESCRIPTION OF SEVERAL PREFERRED EMBODIMENTS

With reference to the above referenced drawings, a speed control device for varying and controlling the speed or other operating parameter of a motor M is overall designated with the reference numeral 1.

Motor M may be any AC or DC motor and is advantageously mounted to any hand held power tool or other small size or miniaturised electrically powered apparatus.

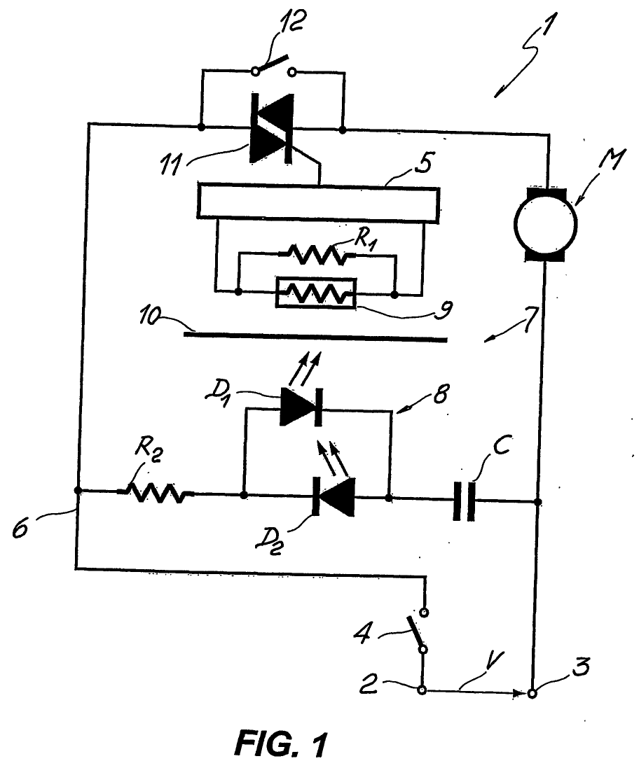

In the embodiment shown in FIG. 1, motor M is of the AC type and is connected to the terminals 2, 3 of an electric power source V by means of the speed control device 1. The electric power source V is usually equal to the power supply voltage, namely 230V in Europe and 115V in North America.

Optionally, a power switch 4 may be serially connected to the terminal 2 of the electric power source V to selectively switch current to the speed control device 1 and to the motor M.

The electric power applied to the motor M is controlled by means of an electronic driver unit 5 serially connected along line 6 of the circuit.

The speed control device 1 comprises an optical switch device 7 for triggering the driver unit 5. More precisely, the optical switch device 7 comprises light emitting means 8 connected in parallel to the electric power source and light transducer means 9 for converting light into an electric variable signal.

The light transducer means 9 may be any photo resistor adapted to detect light and convert it into an electric signal. The photo resistor 9 is connected in parallel to a resistor R₁, is serially connected to the driver unit 5 and sends to this latter an electric signal to control the electric motor M. The output signal coming from the driver unit 5 is sent to a transistor device 11, e.g a thyristor (TRIAC), connected in parallel to a charge switch 12 whose out signal is sent to the AC motor M, which drives the power tool.

A movable shutter or shield 10 is interposed between the light emitting means 8 and the photo resistor 9 and is mechanically connected to a trigger that is slidably or rotatably mounted to a handle or a grip member for being manually operated by a user's finger.

According to the invention, the light emitting means 8 comprise at least one, preferably two white light, high brightness diodes or LEDs respectively designated D₁, D₂ connected in parallel to the electric power source by means of a miniaturised power circuit.

The miniaturised power circuit comprises a capacitor C and an input resistor R₂. The capacitor C allows to apply a tension to the LEDs D₁, D₂ so that the light emitted by these latter is constant as they are connected in parallel and are therefore alternatively activated by the positive and negative semi-waves of the power supply thus operating like a voltage divider.

The resistor R₂ is used as to preserve the white LEDs D₁ and D₂.

In use, the user operates the trigger and causes the shield 10 to move thus allowing to send an electric signal for driving the driver unit 5 by means of the coupling photo resistor 9; this receives the light coming from the LEDs D₁ and D₂, selectively shielded by the shield 10 and converts it into an electrical proportional signal to the driver unit 5.

The driver unit 5 drives the transistor device 11 and sends a driving signal and the appropriate input current to the motor M.

In practice, according to the variation of the light signal received by the photo resistor 9 and according to the logic of control of the driver 5, the TRIAC 11 is able to apply electric current to the motor M in correspondence with the different phase angles reached during each semi-period of the current wave form supplied by the power supply through the switch 4.

The shape of the movable shield 10 positioned between the LEDs D₁, D₂, and the photo resistor 9 may be conveniently shaped to produce a linear or different (e.g. logarithmic, exponential . . . ) resistive variation, according to the use of the power tool or electrically powered apparatus. The above shape can be determined according to tests and trials aimed at getting a convenient user-apparatus interface.

In the development process, the small size of the device in comparison with prior art is also of primary importance. A significant size reduction allows an improvement of the ergonomics of the handle design. This because the components used for this device are of extremely small size (LED with 1 mm side and photo resistors of diameter smaller than 3 mm are widely available) and because said LEDs and photo resistors have a low impact on the production costs; moreover, these costs are well compensated by the advantages this invention offers in terms of lifetime of the machine it is applied to.

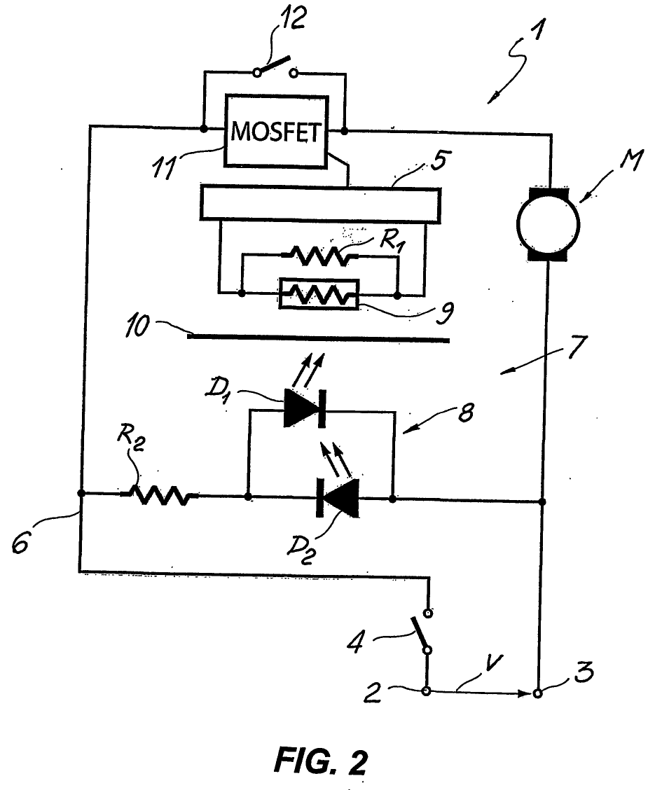

The second embodiment shown in FIG. 2 differs from the previous one essentially in that the electric motor M is of the DC type and is therefore controlled by a MOSFET control circuit 11 driven by the driving unit 5.

In this embodiment, the miniaturised power circuit to supply the LEDs D₁, D₂ is essentially constituted by a small resistor R₂ that in the present case is sufficient to apply the required low tension.

The instant application is based upon and claims priority of patent application no. VI2003A000002, filed on Sep. 01, 2003 in Italy, the disclosure of which is hereby expressly incorporated here in reference thereto.

1. A device for controlling variable speed electric motors, particularly for hand held power tools and other miniaturised electrically powered apparatuses, comprising an electronic driver unit (5) connectable to the terminals (2, 3) of an electric power source for supplying electric current to at least one electric motor (M) and an optical switch device (7) for triggering said electronic driver unit (5), said optical switch device (7) comprising light emitting means (8) and light transducer means (9) for detecting and converting light into an electric variable signal, said light transducer means (9) being operatively connected to said electronic driver unit (5) for controlling said at least one electric motor (M), wherein said light emitter means (8) comprise at least one white light, high brightness LED (D₁, D₂) connected in parallel to the electric power line terminals (2, 3) by means of a miniaturised power circuit.

2. Device as claimed in claim 1, characterised in that said miniaturised power circuit comprises a capacitive phase displacement power supply (C, R2) when said electric motor is an AC motor.

3. Device as claimed in claim 2, characterised in that said capacitive phase displacement power supply comprises at least one capacitor (C) and an input resistor (R2) adapted to supply said LEDs (D1, D2) with a threshold voltage.

4. Device as claimed in claim 1, characterised in that said miniaturised power circuit comprises one resistor (R2) when said at least one electric motor (M) is a DC motor.

5. Device as claimed in claim 1, characterised in that it further comprises a main power switch (4) serially connected to one terminal (2) of the electric, power source (V).

6. Device as claimed in claim 1, characterised in that said at least one LED comprise a pair of miniaturized LEDs (D1, D2) of the surface mounting device (SMD) type.

7. Device as claimed in claim 1, characterised in that said light transducer means (9) is a photo resistor.

8. Device as claimed in claim 7, characterised in that said optical switch device further comprises at least one movable shield (10) operatively connected to a manually operable trigger.

9. Device as claimed in claim 8, characterised in that at least one movable shield (10) is interposed between said LEDs (D1, D2) and said photo resistor (9).

10. Device as claimed in claim 2, characterised in that said electronic driver unit (5) comprises at least one transistor device (11) connected in parallel to a charge switch (12).

11. Device as claimed in claim 10, characterised in that said at least one transistor device (11) is a thyristor (TRIAC).

12. Device as claimed in claim 4, characterised in that said electronic driver unit (5) comprises at least one MOSFET control circuit (11) connected in parallel to a charge switch (12).
